(19) United States
(12) Patent Application Publication
(10) Pub. No.: US 2002/0138371 A1
(43) Pub. Date: Sep. 26, 2002

(54) Online transaction risk management

(76) Inventors: David Lawrence, New York, NY (US); Ajay Junnarkar, New York, NY (US)

Correspondence Address: Clifford Chance Rogers & Wells LLP, 200 Park Avenue, New York, NY, 10166-0153, US

(21) Appl. No.: 09/919,413

(22) Filed: Jul. 31, 2001

Related U.S. Application Data
(63) Continuation-in-part of application No. 09/812,627, filed on Mar. 20, 2001.

(51) Int. Cl. G06F 17/60

(52) U.S. Cl. 705/27

(57) ABSTRACT

A computerized risk management method and system for facilitating analysis and quantification of risk associated with an online transaction. An online transaction risk management system maintains a database relating risk variables including credit ratings, news feeds, world events government advisories, and other information sources with data related to potential risk for a financial institution. The system generates a risk quotient or other rating based upon a weighted algorithm applied to the criteria, wherein the risk quotient is indicative of risk associated with an online transaction. The quotient can be monitored on a periodic basis, during the course of a transaction, or on demand. Actions commensurate with a risk quotient can be presented to an online market participant to help a subscribing online market participant properly manage risk associated with a particular entity or transaction. A log or other stored history can be created such that utilization of the system can mitigate adverse effects relating to a problematic transaction.

### CROSS REFERENCE TO RELATED APPLICATIONS

This application is a continuation-in-part of a prior application entitled “Automated Global Risk Management” filed Mar. 20, 2001, bearing the U.S. patent application Ser. No. 09/812,627, the contents of which are relied upon and incorporated by reference.

### BACKGROUND

This invention relates generally to a method and system for facilitating the identification, assessment and management of legal, regulatory financial and reputational risks (“risks”). In particular, the present invention relates to a computerized system and method for online market participants to quantify and manage financial, legal, regulatory and reputational risk associated with an online transaction according to information relating to who is on the other side of a transaction and the type of transaction which will be executed.

Online retailers or wholesalers; individuals; business to business suppliers; government entities; trading forums; online auctions; bank and non-bank financial institutions, including: investment banks, merchant banks, commercial banks, securities firms (including broker-dealers, and securities and commodities trading firms), asset management companies, hedge funds, mutual funds, credit rating funds, securities exchanges and bourses; institutional and individual investors; law firms; accounting firms; auditing firms and other entities, hereinafter collectively referred to as “online market participants” typically have few resources available to them to assist in the identification of present or potential risks associated with an online business transaction. Risk can be multifaceted and far-reaching. Generally, online market participants do not have available a mechanism to provide real time assistance to assess a risk factor or otherwise qualitatively manage risk. In the event of problems, it is often difficult to quantify to regulatory bodies, shareholders, newspapers and other interested parties the diligence exercised by the online market participant to properly identify and respond to risk factors. Absent a means to quantify good business practices and diligent efforts to contain risk, an online market participant may appear to be negligent in some respect.

Varied and innovative applications have been developed to offer services and conduct business on the Internet. The increased flexibility and continuous availability of the Internet has created a mechanism conducive of many different types of business transactions. One of the advantages of the Internet is that market participants who may not otherwise have ready access to each other now have the ability to locate each other and conduct business together. By freeing the limitations on business hours and geographic markets, this type of access can greatly increase a market participant's customer base and offer important opportunities. However, the automated nature of an online transaction can also carry increased risk of fraud or other suspect practices. The increased number of parties that can interact online has made more difficult to ascertain on a real-time basis the risk that is being assumed with each transaction.

Whereas a customer base may have increased incrementally during any business day using traditional business forums, online markets can be accessed by a multitude of new customers at any time and any day. Customers can present themselves from different geographic areas which may be outside of the jurisdiction that a hosting market participant is accustomed to. In addition, an online market participant can only present themselves in a semi-anonymous fashion, which precludes the use of traditional practices that may have been utilized to detect a high-risk situation.

Risk associated with an online transaction can include factors related to financial risk, legal risk, regulatory risk and reputational risk. Financial risk includes factors indicative of monetary costs that the online market participant may be exposed to as a result of opening a particular account and/or transacting business with a particular client. Monetary costs can be related to fines, forfeitures, costs to defend an adverse position, or other related potential sources of expense. Regulatory risk includes factors that may cause the online market participant to be in violation of rules put forth by a regulatory agency such as the Securities and Exchange Commission (SEC). Reputational risk relates to harm that an online market participant may suffer regarding its professional standing in the industry. An online market participant can suffer from being associated with a situation that may be interpreted as contrary to an image of honesty and forthrightness.

Risk associated with international transactions can be greatly increased due to the difficulty in gathering and accessing pertinent data on a basis timely to managing risk associated with the transaction. As part of due diligence associated with managing international transactions, it is imperative for online market participants to “Know Their Customer”, including whether a customer is contained on a list of restricted entities published by the Office of Foreign Access Control (OFAC), the Treasury Office or other government or industry organization.

Compliance officers and other online market participant personnel typically have few resources available to assist them with the identification of present or potential risks associated with a particular online market participant. Risks can be multifaceted and far-reaching. The amount of information that needs to be considered to evaluate whether an entity poses a significant risk or should otherwise be restricted is substantial.

What is needed is a method and system to monitor online transactions and draw upon a database of information to assist with risk management and due diligence related to executing a transaction online. A new method and system should anticipate offering guidance to personnel who interact with clients and help the personnel identify high-risk situations. In addition, it should be situated to convey risk information to a compliance department and be able to demonstrate that an online market participant has met standards relating to risk containment.

### SUMMARY

Accordingly, the present invention provides a risk management method and system for facilitating analysis and quantification of risk associated with executing an online transaction. An online transaction risk management system (OTMR) maintains a database relating risk variables including credit ratings, collateralization reports, world events, government advisories, type of transaction, identity of transaction participants, venue and other information sources with potential risk for an online market participant. A rating system is used to readily assess risk based upon criteria such as risk advisories, historical data and/or interpretation of world events. The system can generate a risk quotient or other rating based upon a weighted algorithm applied to the criteria, wherein the risk quotient is indicative of risk associated with a transaction, an online market participant and/or a combination of the two. The quotient can be monitored subsequent to consummation of a transaction or on a periodic basis. In addition, an aggregate rating of risk assumed can be calculated and presented to an online market participant. Actions commensurate with a risk quotient or risk aggregate can be presented to an online market participant to help the institution properly manage risk associated with a particular entity or transaction.

In one embodiment, a computer-implemented method for managing risk includes a computer server gathering data generally related to risk variables associated with the online transaction. The server also receives information relating to details of the online transaction, such as the sale of goods, and structures the information received according to risk quotient criteria. A risk quotient is calculated by referencing the structured information and the gathered data. A suggested action responsive to the risk quotient can also be generated.

The information received can be stored as well as the risk quotient and the suggested action. Once stored they can be again referenced to generate a diligence report. The diligence report can also include any actions taken responsive to the risk quotient. A suggested action can also be responsive to the information received and is preferably directed towards reducing risk related to the online transaction.

An online marketplace can allow access from online market participants from different national jurisdictions. Suggested actions can include refusing to perform a transaction and/or blocking access to an online marketplace by a particular online market participant, or even notifying an authority.

Information received by the computer server can go beyond an online market participant to the identity of a high-risk entity and the high-risk entity's relationship to an online market participant. It can also include the identity of a secrecy jurisdiction. The information received can be gathered electronically by real-time monitoring of online transactions.

A log or other stored history can be created such that utilization of the system can mitigate adverse effects relating to a problematic account. Mitigation can be accomplished by demonstrating to regulatory bodies, shareholders, news media and other interested parties that corporate governance is being addressed through tangible risk management processes. In summary fashion, the present invention includes a method and system for identifying risks associated with the domestic and global commercial activities of financial firms including, for example, transactions involving: an online market participant, an insurance company, a credit card issuer, a trading exchange, a government regulator, a law enforcement agency, an investment and merchant bank, public and private financing, commodities and securities trading, commercial and consumer lending, asset management, the ratings of corporations and securities, public and private equity investments, public and private fixed income investments, the listing of companies on securities exchanges and bourses and employee screening (hereinafter collectively referred to as “Financial Transactions”).

In another aspect, a computer system for providing risk management relating to online transactions can include a computer server that is accessible with a network access device via a communications network and executable software stored on the server which is executable on demand via the network access device. The software can be operative with the server to gather or receive information relating to risk factors and formulate a risk quotient or other rating. In addition, where applicable, risk can be aggregated, such as by rating, and transferred.

Other embodiments include a computerized system for managing risk associated with an online transaction, computer executable program code residing on a computer-readable medium, a computer data signal embodied in a digital data stream, or a method of interacting with a network access device. Various features and embodiments are further described in the following figures, drawings and claims.

### DESCRIPTION OF THE DRAWINGS

FIG. 1 illustrates a block diagram that can embody this invention.

FIG. 2 illustrates a network on computer systems that can embody an OTRM system.

FIG. 3 illustrates a flow of exemplary steps that can be executed by a OTRM system.

FIG. 4 illustrates an exemplary graphic user interface (GUI) useful for gathering information according to the present invention.

FIG. 5 illustrates an exemplary GUI useful for presenting reports related to OTRM.

### DETAILED DESCRIPTION

The present invention includes a computerized method and system for managing risk associated with an online transaction. A computerized system gathers and stores information in a database or other data storing structure and relates the information to risk factors pertaining to the transaction. A rating system is used to assess risk based upon the information received and the risk factors. A rating, such as a risk quotient, can be generated to readily indicate a level of risk associated with a particular account or account holding entity. The risk quotient can be based upon a weighted algorithm applied to the risk factors. The risk quotient can be made available on a periodic basis, on demand in real time, in response to an event such as an imminent transaction, or according to some other request. Actions commensurate with a risk level can be presented to assist with proper risk management.

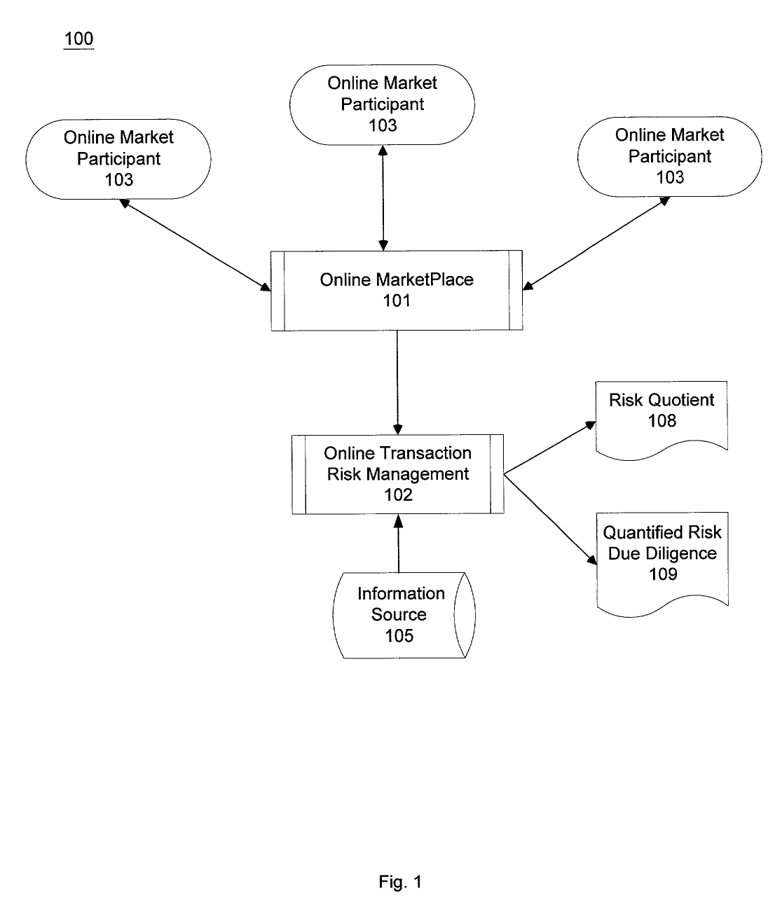

Referring now to FIG. 1, a block diagram of one embodiment of the present invention is illustrated. An online marketplace 101, such as a website equipped to conduct an transaction, interacts with online market participants (OMP) 103. Information gathered during the interaction is ported out to an Online Transaction Risk Management (OTRM) system 102. The OTRM 102 receives the information and process it together with other information contained in a database to determine which transactions are restricted, controlled, or otherwise calculated to be high risk. For example, in one preferred embodiment, an online auction or other online marketplace, for goods or financial instruments can be made accessible to anyone who has access to the Internet. Due to the automated nature of a transaction associated with the online auction, as well as the volume and frequency of interactions, without the present invention, it is difficult to track and analyze all OMPs 103 that contact and interact with the online auction. The present invention automatically transmits information related to a transaction to a OTRM Server 202. The OTRM Server 202 correlates the information received from the online marketplace with other information which it has gathered and generates a risk quotient associated with the transaction.

Information received by the OTRM 102 which relates to the transaction can include, for example, the type of transaction, the amount involved in the transaction, the geographic locations associated with the transaction, government regulations associated with the transaction, currencies involved in the transaction or other related information.

Information received by the OTRM 102 which relates to an OMP 103 can include, for example, information from a list generated by the Office of Foreign Assets Control (OFAC) including their sanction and embargo list, a list generated by the U.S. Commerce Department, a list of international “kingpins” generated by the U.S. White House, U.S. regulatory actions, a foreign government, U.S. adverse business-related media reports, U.S. state regulatory enforcement actions, International regulatory enforcement actions, International adverse business-related media reports, a list of politically connected individuals and military leaders, a list of U.S. and international organized crime members and affiliates, a list of recognized high risk countries or other information sources. Information received may indicate that an OMP 103 is a high risk or is not high risk. For example an OMP 103 that is considered low risk may include a corporation from a G-7 country that is traded on a major exchange.

Information can also be input by an OMP 103. For example, in the course of online interaction, a first OMP 103 may request that another OMP 103 involved in a transaction supply information related to the online transaction, or a first OMP 103 may discover or suspect that another OMP 103 is involved in some fraudulent or otherwise illegal activity and report this information to the OTRM system 102.

A decision by an OMP 103 concerning whether to pursue a financial transaction can be dependent upon many factors. A multitude and diversity of risks related to the factors may need to be identified and evaluated. In addition, the weight and commercial implications of the factors and associated risks can be interrelated. The present invention can provide a consistent and uniform method for business, legal, compliance, credit and other personnel of OMP 103 to identify and assess risks associated with a transaction. An OTRM system 102 allows online transaction risks to be identified, correlated and quantified by an OMP 103 thereby assessing legal, regulatory, financial and reputational exposure.

An OMP 103 can integrate a OTRM system 102 as part of legal and regulatory oversight for various due diligence and “know your customer” obligations imposed by regulatory authorities. The OTRM system 102 can facilitate detection and reporting of potential violations of law as well as address the “suitability” of a financial transaction and/or the assessment of sophistication of a customer. Similarly, the OTRM system 102 can support an OMP 103's effort to meet requirements regarding the maintenance of accurate books and records relating to their financial transactions and affirmative duty to disclose material issues affecting an investor's decisions.

A log or other stored history can be created within the OTRM to track information and how the information was applied to a particular online transaction and/or OMP 103. The log can also be useful to mitigate adverse effects relating to a problematic account. Mitigation can be accomplished by demonstrating to regulatory bodies, shareholders, news media and other interested parties that corporate governance is being addressed through tangible risk management processes. An implementing institution may include, for example, an online retailer or wholesaler; an individual; business-to-business supplier; government entity; trading forum; online auction; bank and non-bank financial institution, including: investment bank, merchant bank, commercial bank, securities firm (including broker-dealers, and securities and commodities trading firms), asset management company, hedge fund, mutual fund, credit rating fund, securities exchange and bourse; institutional and individual investor; law firm; accounting firm; auditing firm or other entity.

Information relating to financial, legal, regulatory and/or reputational risk is received into a computer system comprising the OTRM 102. The computer system applies an algorithm that weights the input information and calculates a risk quotient or similar score or rating. The risk quotient can include, for example, a scaled numeric or alpha-numeric value.

If an OMP 103 reaches or exceeds a risk quotient threshold, the computer system responds with a predetermined action. Actions can include, for example, generating an alert, blocking acceptance of a transaction, creating a report, notifying a compliance department, or other appropriate response. In addition, the system can create a structured history relating to an OPM 103 that can demonstrate due diligence and proper corporate governance. Reporting can be generated from the structured history.

In the case of an online exchange of goods, such as, for example, a retail or wholesale sale, questions can be presented to an OPM 103 by a programmable robot via a GUI. Questions can relate to a particular type of transaction, a particular type of client, type of goods, or other criteria. Other prompts or questions can aid a first OMP 103 in ascertaining the identity of another OPM 103 and the other OPM's 103 beneficial owner. If there is information indicating that an OPM 103 for a proposed online transaction is beneficially owned by a high-risk entity, the first OMP 103 may not wish to consummate the transaction if it is unable to determine the identity of the high-risk entity and his or her relationship to the account holder.

The OTRM system 102 can also receive open queries containing information relating to an individual or circumstance associated with an online transaction and/or provide questions, historical data, world event information and other targeted information to facilitate a determination regarding an at risk entity's source of wealth and of the particular funds involved with a transaction in consideration.

Questions or prompts proffered by the OTRM system 102 can also depend from previous information received. Information generally received, or received in response to the questions, can be input into the OTRM system 102 from which it can be utilized for real time OTRM risk assessment and generation of a OTRM risk quotient 108.

The OTRM risk assessment and OTRM risk quotient 108 can subsequently be made available by the OTRM system 102 to an OMP 103 or personnel interested in the transaction. In one embodiment, the OTRM risk quotient can be made available in real time. A real-time assessment can allow the OTRM system 102 to provide a suggested action, which can be taken to address a particular risk quotient 108. The OTRM system 102 can also take into consideration input any information available to the OTRM 102 in order to generate a suggested action. A suggested action may include; for example, limiting the scope of an online transaction entered into, discontinuing an online transaction associated with high risk participants, notifying authorities, or other appropriate actions.

Another function of the OTRM system 102 can include quantifying risk due diligence 109 by capturing and storing a record of information received and actions taken relating to a OTRM 102 account. Once quantified, the due diligence data can be utilized for presentation to regulatory bodies, shareholders, news media and/or other interested parties, to mitigate adverse effects relating to a problematic account. The data can demonstrate that corporate governance is being addressed through tangible risk management processes.

The OTRM system 102 can also aggregate risk quotient scores 108 to assess a level of OTRM risk being tolerated by the institution. Other calculations, such as, for example, the sum, mean, average, or other calculation can be made by the OTRM system 102 to further analyze OTRM risk of an OMP 103. If desired, a rating can be applied to an institution according to the amount for OTRM risk tolerated by the institution, such as, for example, the average risk tolerated.

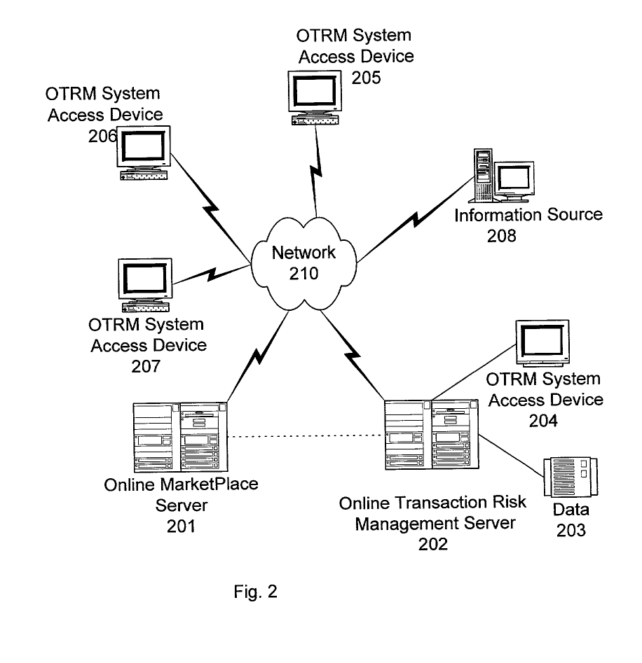

Referring now to FIG. 2, a network diagram illustrating one embodiment of the present invention is shown. An OTRM 102 can include a computerized OTRM Server 202 accessible via a distributed network 210 such as the Internet, or a private network. An OMP 103, or other interested party, can access the OTRM Server 202 using a computerized network access device 204-207 to receive, input, transmit or view information processed in the OTRM Server 202. A protocol, such as the transmission control protocol internet protocol (TCP/IP), can be utilized to provide consistency and reliability in the network communications.

Each network access device 204-207 can include a processor, memory and a user input device, such as a keyboard and/or mouse, and a user output device, such as a display screen and/or printer. The network access devices 204-207 can communicate with the OTRM Server 202 to access data 203 stored at the OTRM Server 202. The network access device 204-207 may interact with the OTRM Server 202 as if the OTRM Server 202 was a single entity in the network 200. However, the OTRM Server 202 may include multiple processing and database sub-systems, such as cooperative or redundant processing and/or database servers, that can be geographically dispersed throughout the network 201. In some implementations, groups of network access devices 204-207 may communicate with OTRM Server 202 through a local area network.

The OTRM Server 202 includes one or more databases 202 storing data relating to OTRM. The OTRM Server 202 may interact with and/or gather data from an operator of a network access device 204-207, such as a retail customer, wholesale customer, business to business personnel, financial entity personnel, regulatory entity, or other person in control of the network access device 204-207. Data gathered from an operator may be structured according to risk criteria and utilized to calculate a OTRM risk quotient 108.

Typically an operator or other user will access the OTRM Server 202 using client software executed at a network access device 204-207. The client software may include a generic hypertext markup language (HTML) browser, such as Netscape Navigator or Microsoft Internet Explorer (a “WEB browser”). The client software may also be a proprietary browser and/or other host access software. In some cases, an executable program, such as a Java™ program, may be downloaded from the OTRM Server 202 to the client computer and executed at the client network access device 204-207 or computer, as part of the OTRM system software. Other implementations include proprietary software installed from a computer readable medium, such as a CD-ROM. The invention may therefore be implemented in digital electronic circuitry, computer hardware, firmware, software, or in combinations of the above. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output.

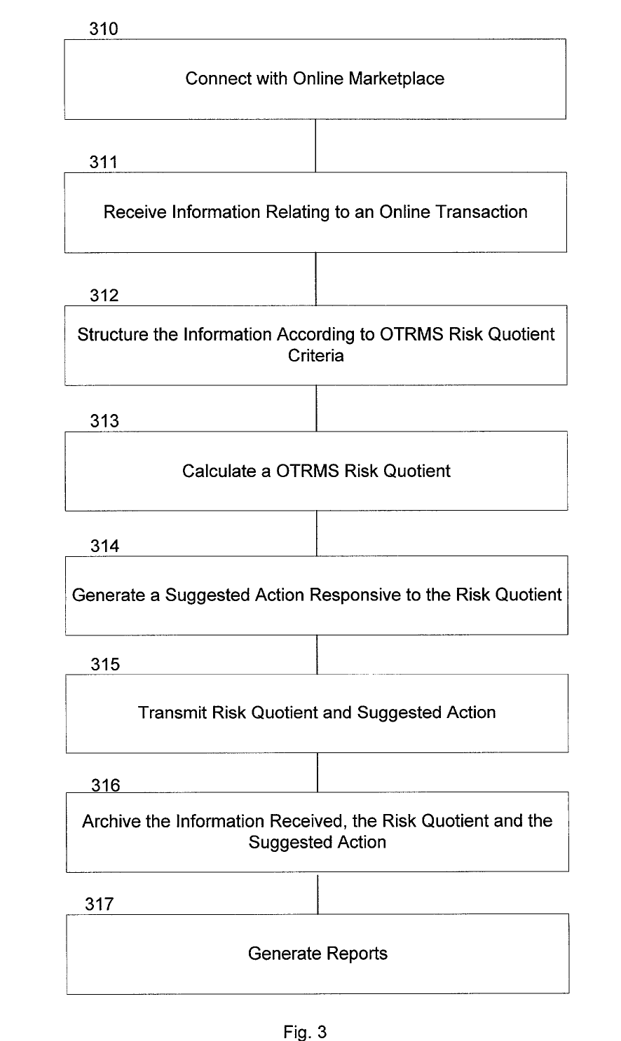

Referring now to FIG. 3, steps taken to manage risk associated with an online transaction can include connecting with an online marketplace 310 in order to monitor online transactions and gather information relating to risk entities and other risk variables. Informational data can be gathered from a user or from a source of electronic data such as an external database, messaging system, news feed, government agency, or other automated data provider. Typically, the OTRM system 102 will receive informational data 311 relating to an OMP 103 or other associated party. Information can be received on an ongoing basis such that if new events which occur in the world which affect the political exposure of an account holder, an OTRM risk quotient 108 can be adjusted accordingly.

In addition to the types and sources of information listed previously that can provide indications of risk, examples of types of information that can indicate a high level of risk associated with an online transaction and which can be received by the OTRM system 202 can include high volumes of transactions, transactions with a value substantially above the norm, information from a foreign entity that relates to requests to involve an OMP 103 that is not accustomed to foreign account activity; requests for secrecy or exceptions to Bank Secrecy Act requirements, routing through a secrecy jurisdiction, or missing wire transfer information; unusual and unexplained fund or transaction activity, such as fund flow through several jurisdictions or OMP 103, use of a government-owned bank, excessive funds or wire transfers, rapid increase or decrease of funds or asset value not attributable to the market value of investments, high value deposits or withdrawals, wires of the same amount of funds into and out of the account, and frequent zeroing of account balance; and large currency or bearer transactions, or structuring of transactions below reporting thresholds. Other information can include activities the OTRM is involved in, associates of the OTRM, governmental changes, or other related events.

Sources of information can include, for example, credit agencies, publications issued by the Treasury Department's Financial Crimes Enforcement Network (“FinCEN”), the State Department, the CIA, the General Accounting Office, Congress, the Financial Action Task Force (“FATF”), various international financial institutions (such as the World Bank and the International Monetary Fund), the United Nations, other government and non-government organizations, internet websites, news feeds, commercial databases, or other information sources.

The OTRM Server 202 can structure information received according to defined OTRM risk quotient criteria 312. For example, information received can be associated with criteria including: a position held by the OMP 103; the company and/or country in which the position is held; how long the position has been held; a credit rating on the OMP 103 or the company which the OMP 103 represents; the veracity of previous dealings with persons from that company and/or country; the propensity of people in similar positions to execute unlawful or unethical transactions; the type of account or other criteria.

The OTRM Server 202 can receive information and structure it according to predefined criteria or receive it in a pre-structured format. Receiving the information in a pre-structured format allows the OTRM Server 202 to proceed with calculating a risk quotient 313 without having to further structure the information. Information that cannot be easily structured can also be received and archived in order to facilitate a manual qualitative evaluation.

A OTRM risk quotient 108 can be calculated 313 by weighting the information received according to its importance in determining high risk activities, such as the likelihood of illegal or unethical dealings. Calculating a OTRM risk quotient 108 can be accomplished by assigning a numerical value to each field of information, wherein the numerical value is representative of the risk associated with a particular piece of information. For example, it may be determined in one case that a government official from a G-7 country trading equities in a public company from a G-7 country poses minimal risk. Therefore this information from the first case is assigned a low numerical value, or even a negative numerical value. In a second case, an individual who appears on a list generated by the FATF and is attempting to transact in a corporate holding company may be viewed as a high risk. In another case, information conveying this high-risk may be assigned a high numerical value. In addition, a weight can be assigned to a OTRM risk category to which the information is assigned. Therefore a designated country may receive a higher weight than the position held, or vice versa. A Risk Quotient can be calculated by multiplying a weighted numerical value of the specific information times the category weighting.

For example, information received may indicate an account holder is a high ranking finance official from a G-7 country. The ownership structure of a company the account holder wishes to transact is a public entity. A public entity may receive a numerical value of −5 because it is a relatively low risk ownership structure. In addition, this information may be included in a Company Profile category, wherein the Company Profile is assigned a category weighting of 3. Therefore, the net score for this ownership structure is −5 times 3 or −15. Similarly the account holder being a high ranking official from a G-7 country may also receive a low number such as 1. The OTRM risk quotient for the account holder would be 1 times 3, or 3. All scores within the Company Profile can be summed to calculate a OTRM risk quotient. In this case the OTRM risk quotient is −15 +3 which equals −12, indicating a low risk. Weighted risk scores from all associated categories can be summed to calculate a total Risk Quotient Score 108.

A suggested action can be generated that is responsive to the Risk Quotient 314. For example, in response to a high-risk score a suggested action include not proceeding with a transaction, blocking access to an online marketplace 101, or even to notify an authority with details of the risk. In response to a low-risk score, the OTRM Server 202 may respond by completing transactions as usual. Intermediate scores may respond by suggesting that additional information be gathered, that transactions for this account be monitored, or other interim measures.

The OTRM Server 202 can also store, or otherwise archive, OTRM data and proceedings. For example the OTRM Server 202 can store information received, a Risk Quotient generated, and also the suggested actions to be taken 315. This information can be useful to quantify corporate governance and diligent efforts to address high-risk situations. Accordingly, reports quantifying OTRM risk management procedures, executed due diligence, corporate governance or other matters can be generated 316.The OTRM Server 202 can receive information during the normal course of business, such as when the participants to a transaction are ascertained.

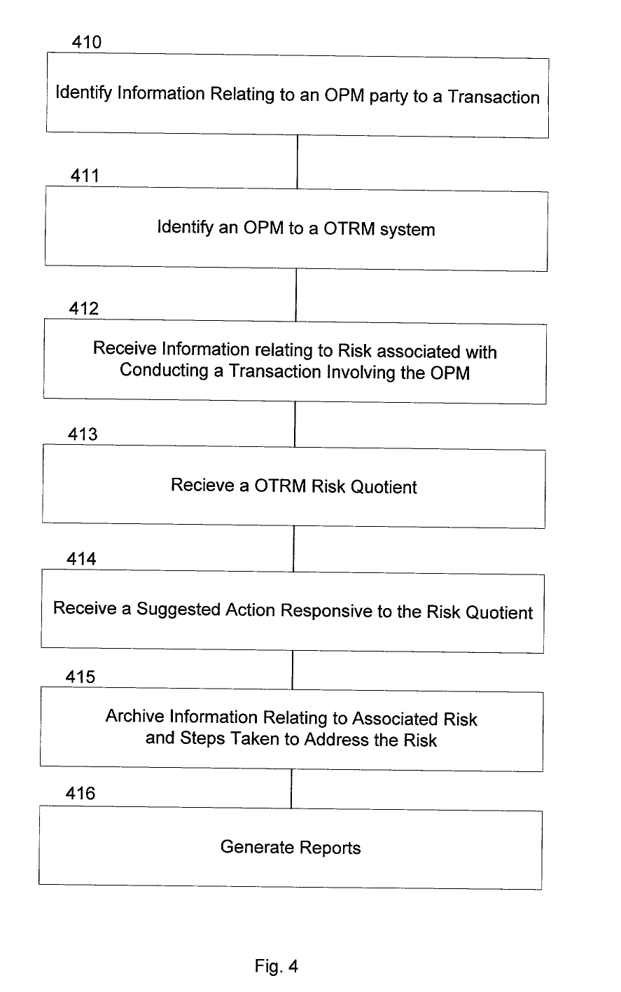

Referring now to FIG. 4, a subscribing OMP 103 can access a OTRM Server 202 and identify to the OTRM Server 202 information relating to an online transaction 410 as well as information relating to one or more OMPs 103, jurisdictions, or other risk variables involved in the transaction 411. Access can be accomplished by opening a dialogue with a OTRM system. Typically, the dialogue would be opened by presenting a GUI to a network access device accessible by a person or an electronic feed that will enter information relating to the account holder. The GUI will be capable of accepting data input via a network access device. An example of a GUI would include a series of questions relating to a client holding an account. Alternatively, information can be received directly into fields of a database, such as from a commercial data source. Questions can be fielded during a transaction, while updating account information, during an account opening interview, or at any other opportunity to gather information.

In one embodiment, automated monitoring software can run in the background of a normal transaction program and screen data traversing an application. The screened data can be processed to determine key words wherein the key words can in turn be presented to the OTRM Server 202 as risk variables. The OTRM Server 202 will process the key words to identify entities or other risk variables and score those variables according to weighted criteria. Monitoring software can also be installed to screen data traversing a network or communications link.

The subscribing OPM 103 can receive back information relating to risk associated with conducting a transaction involving the submitted variables 412. The subscribing OPM 103 can also receive a OTRM Risk Quotient 413. As addressed more completely above, the risk quotient is typically a scaled numerical score based upon values for weighted criteria. It will represent a magnitude of risk associated with a particular transaction and can be based upon the participants involved in a transaction, the type of transaction, the state sovereignties involved, an amount of money involved in the transaction, or other risk variables.

In addition to receiving the OTRM risk quotient 413, the user can also receive one or more suggested actions responsive to the risk quotient 414. A suggested action can include reasonable steps that can be taken by the OMP 103 or other user to address a risk that is associated with the online transaction. The user can also archive information relating to risk associated with a transaction as well as steps taken to address the risk 415. The process involved in utilizing the OTRM system can be included in the archive as steps taken to diligently manage risk associated with an online transaction.

The user can also generate reports to quantify the archived information and otherwise document diligent actions taken relating to risk management.

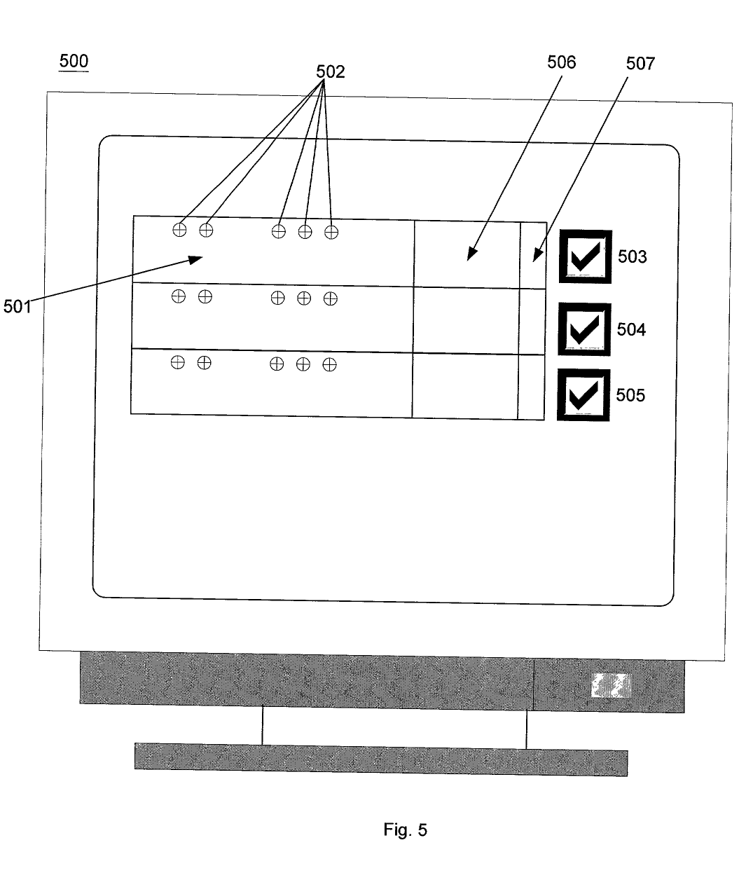

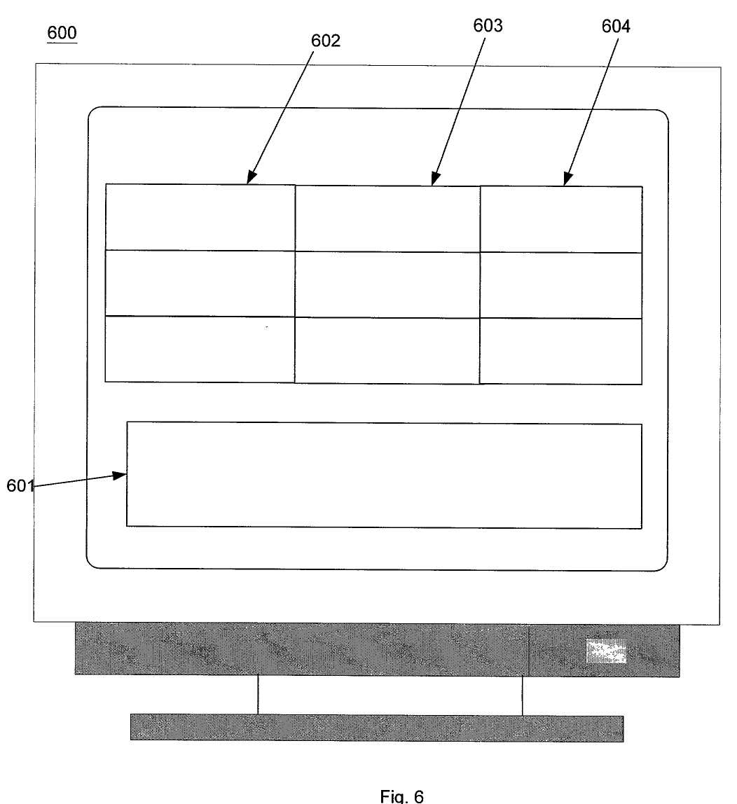

Referring now to FIG. 5, an exemplary GUI for displaying information related to OTRM is illustrated 500. The GUI can include areas prompting for information, such as in the form of a key word or a question 501. Areas can also be included for an appropriate response 506. The area for an appropriate response 506 can, for example, receive text, allow a selection from choices proffered, or otherwise receive data into the OTRM Server 202. A programmable user interactive device, such as a checkbox, X field, yes/no filed or other device 503-505 can also be utilized to indicate an answer, or otherwise input information. Other programmable devices, such as programmable icons, hyperlinks, push buttons or other devices 502 can also be utilized to execute a particular function. A category weighting area 507 can also be indicated on the GUI 500. Typically the weighting will be predetermined. However, if desired the weighting can be modified by a user such that a weighting value, such as a numerical value, will be utilized to calculate a risk quotient. The OTRM GUI 500 can also include an area for displaying a quotient score relating to the transaction 508.

Referring now to FIG. 6, an exemplary GUI for presenting reports or suggested actions related to OTRM is illustrated 600. The GUI for presenting reports 600 can include geographic areas of a user interface containing risk management procedures 601, including those procedures specifically followed in relation to a particular OTRM or other suggested actions. Additional areas can include a list of electronic or hard copy reports available concerning risk management efforts undertaken 602. Another area can include a list of risk quotients and./or calculations concerning a risk quotient, such as the average risk quotient for the OMP 103, or the mean risk quotient 603. Still another area can contain information descriptive of a particular transaction 604.

A number of embodiments of the present invention have been described. Nevertheless, it will be understood that various modifications may be made without departing from the spirit and scope of the invention. For example, network access devices 204-207 can comprise a personal computer executing an operating system such as Microsoft Windows™, Unix™, or Apple Mac OS™, as well as software applications, such as a JAVA program or a web browser. Network access devices 204-207 can also be a terminal device, a palm-type computer, mobile WEB access device, a TV WEB browser or other device that can adhere to a point-to-point or network communication protocol such as the Internet protocol. Computers and network access devices can include a processor, RAM and/or ROM memory, a display capability, an input device and hard disk or other relatively permanent storage. Accordingly, other embodiments are within the scope of the following claims.

What is claimed is:

1. A computer-implemented method for managing risk related to an online transaction, the method comprising:
gathering data generally related to risk variables associated with the online transaction;
receiving information relating details of the online transaction;
structuring the information received according to risk quotient criteria; and
calculating a risk quotient referencing the structured information and the gathered data.

2. The method of claim 1 additionally comprising the step of generating a suggested action responsive to the risk quotient.

3. The method of claim 2 additionally comprising the steps of:
storing the information received, the risk quotient and the suggested action; and
generating a diligence report referencing the stored information.

4. The method of claim 3 wherein the diligence report comprises the information received relating to details of the financial transaction and actions taken responsive to the risk quotient.

5. The method of claim 2 wherein the suggested action is additionally responsive to the information received.

6. The method of claim 2 wherein the suggested action is directed towards reducing risk related to the online transaction which involves online market participants from different national jurisdictions.

7. The method of claim 2 wherein the suggested action comprises refusing to perform a transaction.

8. The method of claim 2 wherein the suggested action comprises blocking access to an online marketplace by a particular online market participant.

9. The method of claim 2 wherein the suggested action comprises notifying an authority.

10. The method of claim 1 wherein the information received comprises the identity of a high-risk entity and the high-risk entity's relationship to an online market participant.

11. The method of claim 1 wherein the information received comprises the identity of a secrecy jurisdiction.

12. The method of claim 1 wherein the information received is gathered electronically by real-time monitoring of online transactions.

13. The method of claim 1 additionally comprising the step of aggregating risk quotients relating to an online market participant to assess a level of identified risk to which the online market participant is exposed.

14. The method of claim 1 additionally comprising the step of calculating an average risk quotient associated with a transaction.

15. The method of claim 1 wherein the online transaction comprises a sale of goods.

16. A computerized system for managing risk associated with an online transaction, the system comprising:
a computer server accessible with a network access device via a communications network; and
executable software stored on the server and executable on demand, the software operative with the server to cause the system to:
gather data related to risk variables for an online transaction;
receive information relating to details of the online transaction;
structure the information received according to risk quotient criteria; and
calculate a risk quotient referencing the structured information and the gathered data.

17. The computerized system of claim 16 wherein the information is received via an electronic feed.

18. The computerized system of claim 16 wherein the information received is generated by a government agency.

19. The computerized system of claim 16 wherein the network access device is a personal computer.

20. The computerized system of claim 16 wherein the network access device is a wireless handheld device.

21. Computer executable program code residing on a computer-readable medium, the program code comprising instructions for causing the computer to:
gather data related to risk variables for an online transaction;
receive information relating to details of the online transaction;
structure the information received according to risk quotient criteria; and
calculate a risk quotient referencing the structured information and the gathered data.

22. A computer data signal embodied in a digital data stream comprising data relating to risk management, wherein the computer data signal is generated by a method comprising the steps of:
gathering data generally related to risk variables associated with the online transaction;
receiving information relating details of the online transaction;
structuring the information received according to risk quotient criteria; and
calculating a risk quotient referencing the structured information and the gathered data.

23. A method of interacting with a network access device so as to manage risk relating to an online transaction, the method comprising the steps of:
initiating interaction with a online transaction risk management server via a communications network;
executing commands on the network access device which cause information relating to details of an online transaction to be transmitted to an online transaction risk management server; and
receiving a risk quotient indicative of a level of risk associated with the transaction.

24. The method of claim 23 wherein the risk quotient is a numerical value.

25. The method of claim 23 additionally comprising the step of receiving a description of suggested action that can be taken to mitigate a level of risk associated with the transaction.
